(19) United States
(12) Patent Application Publication
(10) Pub. No.: US 2008/0025892 A1
(43) Pub. Date: Jan. 31, 2008

(54) Process for the Production of Magnesium Oxide

(76) Inventors: Eric Girvan Roche, Booragul (AU); Graham Andrew Reynolds, Kotara South (AU); Coralie Adele Lewis, Black Hill (AU)

Correspondence Address: BRINKS HOFER GILSON & LIONE, P.O. BOX 10395, CHICAGO, IL, 60610, US

(21) Appl. No.: 11/782,202

(22) Filed: Jul. 24, 2007

Related U.S. Application Data
(63) Continuation-in-part of application No. PCT/AU2006/000094, filed on Jan. 30, 2006.

(30) Foreign Application Priority Data
Feb. 1, 2005 (AU) 2005900431

(51) Int. Cl. C01F 1/00

(52) U.S. Cl. 423/158

(57) ABSTRACT

A process for the recovery of magnesium oxide from a source containing magnesium salts, said process including the steps of: (a) adding an alkali and sulfur dioxide to the source containing magnesium salts, in a leach step to form a magnesium bi-sulfite containing leachate;(b) separating the insoluble materials from the leachate; (c) stripping excess sulfur dioxide from the leachate and precipitating the magnesium as solid magnesium sulfite hydrate; (d) separating the solid magnesium sulfite hydrate from the magnesium depleted leachate; and (e) calcining the solid magnesium sulfite hydrate and recovering the magnesium as magnesium oxide.

The present application claims priority to and is a continuation-in-part application of PCT/AU2006 000094 filed Jan. 30, 2006 and published in English on Aug. 10, 2006 as WO 2006/018165 and of AU 2005-900431 filed Feb. 1, 2005, the entire contents of each are incorporated herein by reference.

The present invention relates to a process for the production of magnesium oxide. In particular, it relates to a low cost method of producing magnesium oxide from spent magnesium salts.

### BACKGROUND OF THE INVENTION

Magnesium oxide, or magnesia, is used relatively extensively in the mining industry, for example in hydrometallurgical refining processes for metal recovery. One particular use for magnesium oxide is as a neutralizing agent to control the pH of acidic solutions. In nickel recovery processes, it is used to raise the pH of an acidic solution containing dissolved nickel and cobalt ions, to precipitate nickel and cobalt from acidic solutions as nickel and cobalt hydroxides.

One such process is the Cawse project that operates in Western Australia for the recovery of nickel and cobalt from laterite ores. The Cawse project utilizes solid magnesium oxide or freshly slurried magnesium oxide to precipitate dissolved nickel and cobalt from acidic solutions obtained from pressure acid leaching of laterite ores. BHP Billiton's Ravensthorpe process also proposes to recover nickel and cobalt as a mixed nickel and cobalt hydroxide product.

Generally, good quality magnesium oxide is not widely available and needs to be imported into a nickel refinery process, as is done in the Cawse project. This can add considerably to the cost of the nickel recovery process.

Laterite ores include both a high magnesium content saprolite component, and a low magnesium content limonite component. In commercial processes such as the Cawse process, nickel and cobalt are recovered from laterite ore by high pressure acid leach processes where the nickel and cobalt are leached from the ore with sulfuric acid and precipitated as a mixed hydroxide following the addition of magnesium oxide. Other non commercial processes have been described where a mixed hydroxide precipitate is produced in a similar manner by atmospheric pressure acid leaching, or a combination of high pressure and atmospheric pressure leaching, or heap leaching of the laterite ore.

During such nickel recovery processes, magnesium values contained in the saprolitic silicates of nickel containing laterite ores are generally discarded as waste. The magnesium solubilized from the magnesium oxide used in the process is also discarded as waste. The dissolved magnesium generally reports to brine ponds associated with the refinery as magnesium sulfate or magnesium chloride brine.

The brine pond material is generally regarded as a waste product of the process. Metal values in the rejects material are lost when discarded as tailings and may also cause environmental concerns. The present invention aims to provide a new process which overcomes or at least alleviates one or more of the problems associated with the need to send potentially useful magnesium to brine ponds during metal recovery processes. The present invention further aims to provide an economic source of good quality magnesium oxide for use in metal recovery processes.

The above discussion of prior processes is included in the specification solely for the purpose of providing a context for the present invention. It is not suggested or represented that these processes formed part of the prior art base or were common general knowledge in the field relevant to the present invention before the priority date.

### SUMMARY OF THE INVENTION

Magnesium oxide and magnesium hydroxide are used in hydrometallurgical nickel recovery processes as neutralizing agents. Magnesium oxide is used as a neutralizing agent to recover nickel and cobalt as nickel and cobalt hydroxides from acid solutions during commercial acid leach processing of nickel containing laterite ores. Magnesium dissolved from the use of magnesium oxide and from magnesium silicates contained in the saprolitic portion of a nickel containing laterite ore is generally discarded as waste material to tailings during such processes. Generally, the discarded magnesium will be sent to a brine pond and exist as salts, such as magnesium sulfate and/or magnesium chloride. Preferably, the invention relates to the conversion of magnesium salts, such as magnesium sulfate and/or magnesium chloride recovered from a brine pond, to magnesium oxide.

In particular, the present invention resides in a process for the recovery of magnesium oxide from a source containing magnesium salts, said process including the steps of:
(a) adding an alkali and sulfur dioxide to the source containing magnesium salts, in a leach step to form a magnesium bi-sulfite containing leachate;
(b) separating the insoluble materials from the leachate;
(c) stripping excess sulfur dioxide from the leachate and precipitating the magnesium as solid magnesium sulfite hydrate;
(d) separating the solid magnesium sulfite hydrate from the magnesium depleted leachate; and
(e) calcining the solid magnesium sulfite hydrate and recovering the magnesium as magnesium oxide.

### BRIEF DESCRIPTION OF THE DRAWINGS

FIG. 1 illustrates a preferred flowsheet for the process of the invention. It should be understood that the drawing is illustrative of a preferred embodiment of the invention and the scope of the invention should not be considered to be limited thereto.

FIG. 2 illustrates the pH and solution potential for the solution prepared and described in Example 1.

### DETAILED DESCRIPTION OF THE EMBODIMENTS

In a preferred embodiment of the invention, the source of magnesium salts used in the process of the invention will generally come from waste material that has been discarded to tailings during a hydrometallurgical nickel recovery process. However, the invention is not limited to such a source of magnesium salts and any conveniently available source of magnesium salts may be used. In the preferred embodiment, the magnesium salts will be present in a brine pond associated with a processing refinery, so the brine pond can act as a ready source of magnesium salts. Where magnesium oxide is used in a nickel recovery process, or where the magnesium rich saprolite fraction of laterite ore is processed, the magnesium salts will generally exist as magnesium sulfate or magnesium chloride. In the preferred embodiment of the invention, brine containing magnesium sulfate and/or magnesium chloride salts is processed.

In a first leach step, where magnesium sulfate salts are present, the brine containing the magnesium salts is processed by adding an alkali such as calcium carbonate (limestone), together with sulfur dioxide to convert the magnesium sulfate to magnesium bi-sulfite. The alkali and the SO₂ may be added together, separately or as a premixed reagent. Limestone is normally cheap and widely available and is the preferred alkali, but could be replaced by calcrete, dolomite, slaked or unslaked lime, dolime (calcined dolomite), caustic soda, sodium carbonate or other suitable alkalis, where the economics are suitable.

In the embodiment of the invention where magnesium chloride is present in the brine rather than, or together with magnesium sulfate, a soluble sulfate, such as sodium sulfate should also be added together with a calcium containing alkali and the sulfur dioxide to produce magnesium bi-sulfite in solution and insoluble gypsum.

The soluble magnesium bi-sulfite will be present in the resultant leachate solution. The insoluble material, such as anhydrite, gypsum, or gangue, is separated from the magnesium bi-sulfite leachate solution; and together with unconverted calcium carbonate and other insoluble materials, may be discarded as waste or beneficiated to produce saleable products if desired. Carbon dioxide is released as a gas.

The leach step, where the salt is magnesium sulfate and calcium carbonate is the alkali, may be summarized by the equation:
MgSO₄+CaCO₃+2SO₂+3H₂O→Mg(HSO₃)₂+CaSO₄.2H₂O+CO₂
Where magnesium chloride is the salt, calcium carbonate the alkali and sodium sulfate is also added, the leach step may be summarized by the equation:
MgCl₂+Na₂SO₄+CaCO₃+3H₂O→Mg(HSO₃)₂+CaSO₄.2H₂O+2NaCl+CO₂

The leach step is operable at moderate temperature, preferably between about 30° C. to 70° C., most preferably about 50° C. Preferably the pH of the system will be around pH 1.5 to 2.5, most preferably about 2. With these pH conditions, and with excess SO₂, the soluble magnesium bi-sulfite (Mg(HSO₃)₂) will form rather than the nearly insoluble magnesium sulfite (MgSO₃). The calcium is precipitated as anhydrite or gypsum. Whereas calcium bi-sulfite is also soluble, at a pH of around 2, the calcium would precipitate as gypsum rather than remain as calcium bi-sulfite in solution. At a pH of around 2 and at 50° C., limestone utilization efficiency should be around 90%.

As an alternative to adding SO₂ and alkali directly into the leach stage, the alkali and SO₂ may be premixed to produce a bi-sulfite reagent, which on addition to the Mg containing brine generates the magnesium bi-sulfite. Where the alkali is calcium carbonate and magnesium sulfate is the salt, this two step process may be summarized in the following equations:
CaCO₃+2SO₂+H₂O→Ca(HSO₃)₂+CO₂
Ca(HSO₃)₂+MgSO₄+2H₂O→CaSO₄.2H₂O+Mg(HSO₃)₂
This alternative would, for example, allow the separation of a clean gypsum product free from contaminants such as insoluble gangue.

Where the magnesium salts source is the tailings from acid leaching of a laterite ore, the sulfuric acid required is often produced on site, and the sulfuric acid plant may provide a cheap source of make up sulfur dioxide for the leach step.

The magnesium bi-sulfite leachate is then separated from the insoluble matter by filtration, thickening or other well known means.

Excess sulfur dioxide is then removed from the magnesium bi-sulfite leachate. This is preferably achieved by subjecting the leachate to air stripping by the addition of air. Alternatively, the leachate may be boiled to convert the magnesium bi-sulfite to magnesium sulfite hydrate. The sulfur dioxide removal step may be summarized by the following equation:

air or heat
Mg(HSO₃)₂+(x−1)H₂O→xMgSO₃.H₂O+SO₂
Sulfur dioxide released during this process may be recycled to the leach step and used as a source of sulfur dioxide for that step.

The sulfur dioxide removal step is based on the equilibrium driven desorption of sulfur dioxide from the solution. Some of the magnesium sulfite hydrate may be oxidized to magnesium sulfate by the air stripping process, however the magnesium sulfate would then report back to the brine pond and be reprocessed. Alternatively, an inert gas or mixture of gases may be used to suppress undesirable oxidation, for example nitrogen, carbon dioxide, argon or the like.

Air stripping would also increase the pH of the solution by removing sulfurous acid. The ideal pH for maximizing magnesium sulfite hydrate yield is around pH 7, however magnesium sulfite will form at a pH of from about 4.5 to 10. In the preferred embodiment, the process is run until a pH of between 5 and 7 is achieved.

Heat from the off gases of the kiln used for the calcination step may be used as a heat source for boiling the leachate if required and/or as a source of inert gasses for stripping SO₂ from the solution.

The insoluble magnesium sulfite hydrate may be separated from the magnesium depleted leachate by means of thickening, filtration or other well known means. Washing of the precipitate may be used to remove soluble contaminants such as halides, which may be undesirable in the final product. Water may be used to wash the precipitate. The magnesium-depleted leachate may be discarded or alternatively reused in the process, for example for counter-current decantation (CCD) washing of the laterite leach residue.

The magnesium sulfite hydrate is then calcined, in a calciner at a temperature preferably between about 250 to 350° C., most preferably about 300° C. Calcination at this temperature will remove any water as steam, and release further sulfur dioxide gas which can be recycled and reused in the leach step. A predrying step may be used prior to calcination, to improve the handling characteristics of the magnesium sulfite hydrate solid, and/or to reduce the fuel requirements during calcination. The magnesium sulfite hydrate is converted to magnesium oxide during the calcination process. The recovered magnesium oxide may then be used for commercial purposes, such as in a nickel recovery process. The calcination step may be summarized in the following equation:
MgSO₃.xH₂O+MgO+SO₂+xH₂O
Calcination of magnesium sulfite hydrate can occur at relatively low temperatures, preferably around 300° C. It is an advantage that calcination occurs at this temperature in that the magnesium oxide produced should have maximum activity, particularly for optimization of the mixed hydroxide precipitation in nickel and cobalt production. High temperature calcination, for example greater than 900° C. is known to produce inactive magnesium oxide.

In order to avoid magnesium sulfate contamination of the magnesium oxide during calcination due to oxidation, the design of the calciner should be chosen to minimize this issue. Some magnesium sulfate in the magnesium oxide is unlikely to be a problem however, since there is abundant magnesium sulfate present during a mixed hydroxide precipitation process in any event.

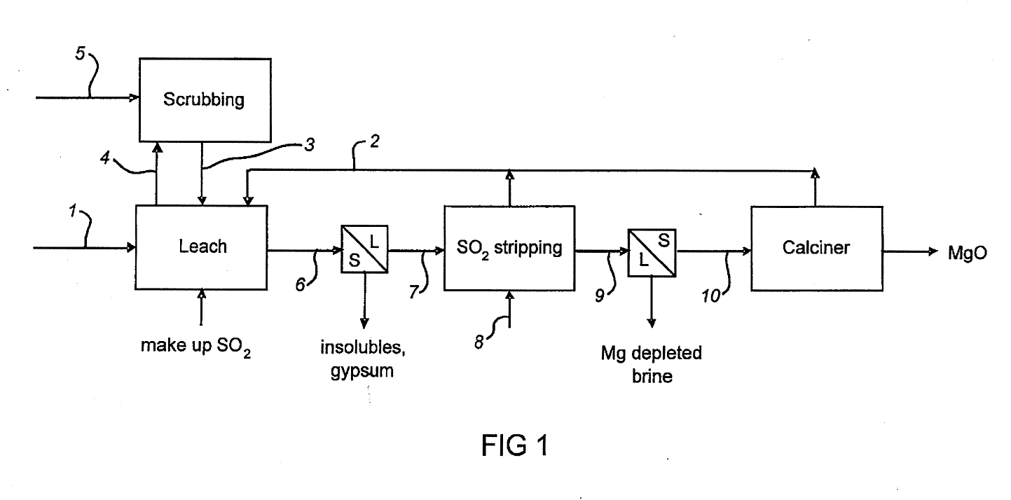

FIG. 1 illustrates a flowsheet where magnesium sulfate brine (1) is contacted with sulfur dioxide containing gas (2) and a limestone slurry (3) in one or more reactors to leach the magnesium as magnesium bi-sulfite. The sulfur dioxide (2) has been recovered and recycled from downstream steps. Some further sulfur dioxide may be added to make up sufficient volume of SO₂ for example, SO₂ from the sulfuric acid plant associated with a nickel refinery operation. Off-gas (4) is scrubbed with a limestone slurry (5) to recover unreacted SO₂ and allow venting of inert gases to the atmosphere. The slurry (6) of insoluble matter and calcium sulfate (gypsum or anhydrite) is filtered and washed with water.

The leachate (7) containing dissolved magnesium bi-sulfite is stripped by air (8) to remove the excess SO₂ (which SO₂ is returned to the leach step) and to precipitate magnesium sulfite hydrate. The magnesium sulfite slurry (9) is filtered and the solids washed with water. The magnesium depleted brine is returned for CCD washing. The washed magnesium sulfite hydrate solids (10) are calcined to produce magnesium oxide powder, which on cooling is used in a mixed hydroxide precipitation in a nickel recovery process. Sulfur dioxide off-gas from the calciner is recovered (2) and returned to the leach step. Off-gas from the calciner may also be used as a source of heat for the SO₂ stripping step (8) and/or scrubbing the off-gas (4) from the leach step.

A particular advantage of the present invention is that magnesium oxide can be produced in sufficient quantities from waste material at the site of a metal recovery processing plant for considerably less cost than if the magnesium oxide had to be brought into the plant. The process used to recover the magnesium oxide would involve process equipment generally available at such processing plants and may be operated under relatively mild and non-corrosive conditions.

A further advantage is that the sulfur dioxide required for the leach step, in general is produced during the process and is readily recycled for use in the leach step. Further to this, where the magnesium salts source is the tailings from acid leaching of a laterite ore, the sulfuric acid required is often produced on site, and the sulfuric acid plant may provide a cheap source of make up sulfur dioxide for the leach step.

### EXAMPLES

### Example 1

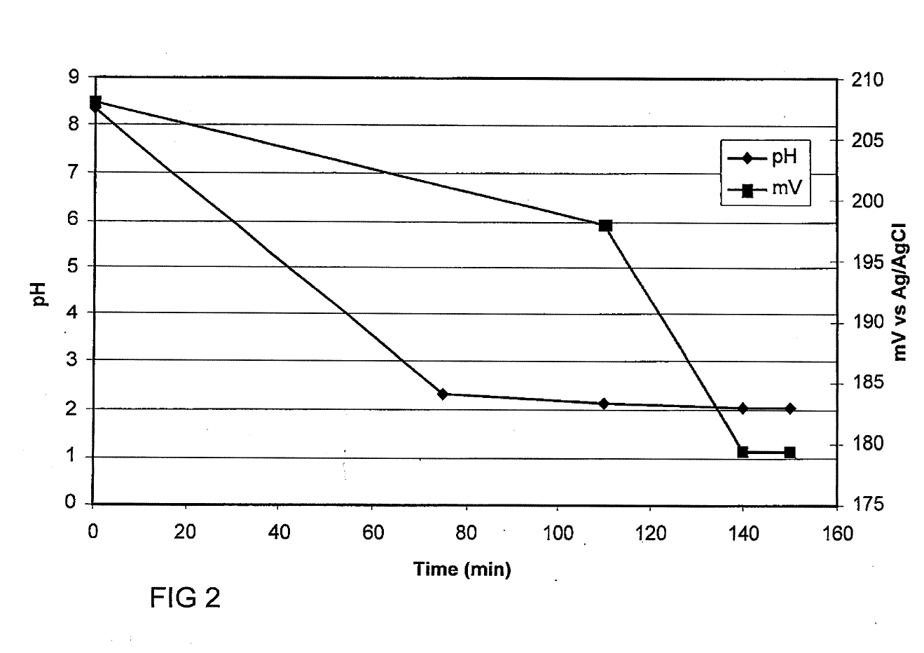

A magnesium sulfate solution (0.5 L) containing 45 g/L Mg. 0.3 g/L Ca and 61 g/L S (as analyzed by ICP) was placed in a beaker equipped with a stirrer and sparge pipe. Limestone (87.4 g) was added and the mixture was stirred at ambient temperature. The pH of the mixture was measured and found to be 8.36. Sulfur dioxide gas was injected into the mixture at 30 g/min. The pH and solution potential (vs AgAgCl) are shown in FIG. 2. After 105 minutes the pH reached 2.04 and sparging was stopped. The slurry was filtered and the solids washed and dried, giving 139.2 g dry weight of crystals. Analysis by XRF showed these to be gypsum, containing 23.5%; Ca, 0.0%; Mg, and 18.3%; S. The filtrate (325 mL) was analysed by ICP and was found to contain 43 g/L Mg 0.4 g/L Ca and 309 g/L S.

### Example 2

The solution (305 mL) prepared as described in Example 1 was heated at the boiling point, with stirring, for 1.5 hrs. On completion, the slurry was filtered and the solids washed and dried, giving 65.6 g of colourless crystals. XRD analysis of the crystals showed them to comprise mainly MgSO₃, 3H₂O. Analysis by XRF showed the solids to contain 15.2%; Mg. 0.7%; Ca, and 20.9%; S.

The magnesium sulfite hydrate produced in accordance with the process shown in Example 2 may then be calcined to produce an active magnesium oxide product. Low temperature calcination of magnesium sulfite to magnesium oxide is demonstrated for example in U.S. Pat. No. 3,681,020 (Shah) which discloses a calcine temperature of 300° C. to 700° C. and U.S. Pat. No. 5,439,658 (Johnson et al.,) which discloses a temperature of 800° F. (426° C.).

The above description is intended to be illustrative of the ambit of this invention with reference to the preferred embodiment. Variation without departing from the spirit or ambit of the invention should be considered to also form part of the invention described herein.

1. A process for the recovery of magnesium oxide from a source containing magnesium salts, said process including the steps of:
(a) adding an alkali and sulfur dioxide to the source containing magnesium salts, in a leach step to form a magnesium bi-sulfite containing leachate;
(b) separating the insoluble materials from the leachate;
(c) stripping excess sulfur dioxide from the leachate and precipitating the magnesium as solid magnesium sulfite hydrate;
(d) separating the solid magnesium sulfite hydrate from the magnesium depleted leachate; and
(e) calcining the solid magnesium sulfite hydrate and recovering the magnesium as magnesium oxide.

2. A process according to claim 1 wherein the source of magnesium salts is a brine pond associated with the tailings from the acidic leaching of nickel containing laterite ores in a nickel recovery process.

3. A process according to claim 1 wherein the magnesium salts are magnesium sulfate and/or magnesium chloride.

4. A process according to claim 1 wherein the alkali is selected from calcium carbonate, calcrete, dolomite, slaked or unslaked lime, dolime, caustic soda or sodium carbonate.

5. A process according to claim 1 wherein the magnesium salts include at least magnesium chloride.

6. A process according to claim 5 wherein the alkali is a calcium containing alkali and the process includes the further step of adding a soluble sulfate together with the alkali and the sulfur dioxide.

7. A process according to claim 6 wherein the soluble sulfate is sodium sulfate.

8. A process according to claim 1 wherein exit gases from the leach step are scrubbed using an alkali to recover unreacted sulfur dioxide.

9. A process according to claim 8 wherein unused alkali from the scrub step is added to the leach step as part or all of the alkali requirement for that step.

10. A process according to claim 9 wherein the alkali is a limestone slurry.

11. A process according to claim 1 wherein the insoluble material separated from the leachate is anhydrite, gypsum or gangue, unconverted calcium carbonate or other insoluble materials.

12. A process according to claim 11 wherein the anhydrite, gypsum and gangue separated from the leachate are beneficiated to produce saleable products.

13. A process according to claim 1 wherein the leach step is carried out at a temperature of between about 30° C. to 70° C.

14. A process according to claim 1 wherein the pH of the system when the leach step is carried out is in the range of from 1.5 to 2.5.

15. A process according to claim 1 wherein the sulfur dioxide and alkali are premixed to produce a bi-sulfite reagent, and then added to the source containing magnesium salts in the leach step to produce the magnesium bi-sulfite containing leachate.

16. A process according to claim 15 wherein clean gypsum is precipitated from the leachate.

17. A process according to claim 1 wherein the insoluble materials are separated from the leachate by filtration or thickening.

18. A process according to claim 1 wherein the excess sulfur dioxide is stripped from the leachate and the magnesium bi-sulfite converted to magnesium sulfite by subjecting the leachate to heating, or air stripping by the addition of air or inert gas.

19. A process according to claim 18 wherein the heat from the off gases of the calciner used to calcine the magnesium sulfite hydrate is used to boil the leachate, if required, and/or as a source of inert gases.

20. A process according to claim 18, wherein the pH of the leachate is maintained between 4.5 to 10 following the sulfur dioxide strip step to maximize-magnesium sulfite hydrate yield.

21. A process according to claim 20, wherein the process is run until the pH of the leachate is between 5 to 7.

22. A process according to claim 18 wherein the stripped sulfur dioxide is recycled to the leach step and used as a source of sulfur dioxide for that step.

23. A process according to claim 1 wherein an inert gas or mixture of gases is used to suppress oxidation of the magnesium sulfite to avoid oxidation of the magnesium sulfite to magnesium sulfate before calcination.

24. A process according to claim 1 wherein the inert gas or mixture of gases is selected from nitrogen, carbon dioxide or argon.

25. A process according to claim 1 wherein the magnesium sulfite is calcined in a calciner at a temperature of between about 250° C. to 350° C.

26. A process according to claim 21 wherein sulfur dioxide released during the calcining step is recycled to the leach step and used as a source of sulfur dioxide for that step.

27. A process according to claim 1 wherein make-up sulfur dioxide, if needed, for the leach step is sourced from the sulfuric acid plant associated with a nickel refinery process.

28. A process according to claim 1 wherein the magnesium sulfite hydrate is separated from the magnesium depleted leachate by means of thickening or filtration.

29. A process according to claim 2 wherein the magnesium depleted solution is reused in the nickel recovery process for counter current decantation washing of laterite leach residue in that process.

30. A process according to claim 1 wherein the magnesium sulfite solid is pre-dried prior to calcination, to improve handling characteristics and reduce the fuel requirements.

31. A process according to claim 2 wherein the magnesium oxide recovered in the process is of sufficient activity to be useful as a neutralizing agent in the nickel recovery process.
